(19) United States
(12) Patent Application Publication
(10) Pub. No.: US 2010/0253024 A1
(43) Pub. Date: Oct. 7, 2010

(54) Safe-T-Ox Cart

(76) Inventor: Joseph Anthony Lewis, JR., Saginaw, TX (US)

Correspondence Address: Joseph Lewis, Jr., 833 Mockingbird Dr, Saginaw, TX, 76131, US

(21) Appl. No.: 12/750,561

(22) Filed: Mar. 30, 2010

Related U.S. Application Data
(60) Provisional application No. 61/211,360, filed on Mar. 30, 2009.

(51) Int. Cl. B62B 1/00

(52) U.S. Cl. 280/47.26

(57) ABSTRACT

In order to solve the problems associated with the dangers and hazards related to compressed oxygen cylinders, the Safe-T-Ox Cart was invented. The Safe-T-Ox Cart consists of a saddle device which hinges on the main body of the Safe-T-Ox Cart. The saddle device consists of two parts. The first, an anterior positioned retainer device, designed to fit snugly around the narrowing top portion of the oxygen cylinder. The second, a posterior positioned keyed locking area, designed to lock the retainer device into position. The purpose of the saddle device is to secure the oxygen cylinder within the Safe-T-Ox Cart, thus preventing unauthorized removal of the oxygen cylinder.

This utility patent application is filed in reference to U.S. Provisional Patent Application No. 61/211,360, filed Mar. 30, 2009 by Joseph Anthony Lewis, Jr.

### BACKGROUND OF INVENTION

The present invention directly impacts practices related to the mobility and safe use of compressed oxygen cylinders. Specifically, the invention relates directly to the safe use, handling, and mobility of compressed oxygen “e” cylinders. “E” refers to the specific size of oxygen cylinders. So for the purpose of this document, any and all references made to oxygen cylinders, refers to size “e” oxygen cylinders.

Compressed oxygen cylinders are widely used in various industries. Compressed oxygen cylinders when left not properly stored or secured create potentially fatal environmental hazards. For instance, if the stem of a compressed oxygen cylinder was to become damaged or dislodged the result would be rapid decompression of the cylinder, which will result in a, missile like, projectile object. This scenario creates dangerous conditions for all people in the general area of the cylinder.

Two wheeled oxygen carts have been utilized by the healthcare industry, as well as, members of society requiring supplemental oxygen use on a regular basis. While the current two wheeled oxygen carts serve a purpose, they also lack in several key areas, especially related to healthcare safety. In terms of hospital and healthcare environment safety, the current two wheeled oxygen carts do not prevent the removal of the oxygen cylinder. Any able person has the ability to remove the oxygen cylinder from the cart and do so with the cylinder as they please. Other unsafe practices arising from the use of the current two wheeled carts include, but or not limited, cylinders placed horizontally on the ground, cylinders placed in beds alongside patients, cylinders left unattended beneath beds, cylinders unaccounted for, and back injuries associated with lifting awkward cylinders in and out of carts.

### SUMMARY OF INVENTION

An object of the invention is to overcome the drawbacks relating to the compromised designs and inherent flaws of prior devices as discussed above.

Hence, to address the major compromises associated with compressed oxygen cylinders and the current two wheeled carts in use, the Safe-T-Ox Cart was invented. The Safe-T-Ox Cart is designed and intended for use with oxygen cylinders only. The Safe-T-Ox Cart was invented to prevent unauthorized removal of oxygen cylinders, from the cart, by unauthorized personnel. To accomplish this, the Safe-T-Ox Cart was designed to consist of a saddle device comprised of a locking retainer and a keyed locking area. The retainer device is the anterior portion of a saddle that hinges upward to lock the cylinder into the cart, and downward to allow removal of the cylinder. The posterior segment of the saddle consists of a keyed lock that also hinges upward and downward, however in an inverse direction of the anterior retaining device. Together these parts work together to make up what is referred to as the hinging saddle.

The Safe-T-Ox Cart utilizes the two wheeled approach to provide mobility and stability. The Safe-T-Ox Cart is designed with two 5 inch wheels (10) mounted on a single axle. The distance between the wheels is approximately 7.54 inches. The base (9) of the Safe-T-Ox Cart is designed to support the cylinder, provide anterior stability, and provide a fender area to cover both wheels. The base of the Safe-T-Ox Cart measures approximately 10.3 inches wide, 11.1 inches at the base of the wheels, approximately 10.15 inches in depth, and extends outward approximately 3.65 inches from the front of the cylinder.

The Safe-T-Ox Cart utilizes a handle (7) to allow for easy maneuvering. An inverted hook (8) is positioned along the posterior spine of the Safe-T-Ox Cart to allow the Safe-T-Ox Cart to hang on a headboard or footboard of a hospital bed or stretcher.

### BRIEF DESCRIPTIONS OF DRAWINGS

Having thus described the invention in general terms, reference will now be made to the accompanying drawings, which are not drawn to scale, and wherein:

FIG. 1 shows a side view of the Safe-T-Ox Cart with the saddle device in the open position. From this view you can see the anterior (1) and posterior (2) portion of the saddle device, as well as, the handle (7), inverted hook (8), locking area (3), main body segment (6), base (9), and a wheel (10).

FIG. 2 shows a side view of the Safe-T-Ox Cart with the saddle device in the locked position. From this view you can see the anterior (1) and posterior (2) portion of the saddle device, as well as, the handle (7), inverted hook (8), main body segment (6), base (9), and a wheel (10).

FIG. 3 shows a perspective view of the Safe-T-Ox Cart with the saddle device in the open position. From this view you can see the anterior (1) and posterior (2) portion of the saddle device, as well as, the handle (7), inverted hook (8), main body segment (6), base (9), and a wheel (10).

FIG. 4 shows a perspective view of the Safe-T-Ox Cart with the saddle device in the locked position. From this view you can see the anterior (1) and posterior (2) portion of the saddle device, as well as, the handle (7), inverted hook (8), main body segment (6), base (9), and a wheel (10).

FIG. 5 shows an anterior view of the Safe-T-Ox Cart with the saddle device in the open position. From this view you can see the anterior (1) portion of the saddle device, as well as, the handle (7), main body segment (6), base (9), and the base of both wheels (10).

FIG. 6 shows an anterior view of the Safe-T-Ox Cart with the saddle device in the locked position. From this view you can see the anterior (1) portion of the saddle device, as well as, the handle (7), main body segment (6), base (9), and the base of both wheels (10).

FIG. 7 shows a posterior view of the Safe-T-Ox Cart with the saddle device in the open position. From this view you can see the posterior (2) portion of the saddle device, as well as, the handle (7), inverted hook (8), locking area (3), main body segment (6), and both wheels (10).

FIG. 8 shows a posterior view of the Safe-T-Ox Cart with the saddle device in the locked position. From this view you can see the posterior (2) portion of the saddle device, as well as, the handle (7), inverted hook (8), main body segment (6), and both wheels (10).

FIG. 9 shows a bird's eye view of the Safe-T-Ox Cart with the saddle device in the open position. From this view you can see the anterior (1) and segments of the posterior (2) portion of the saddle device, as well as, the handle (7), base (9), and the back segments of both wheels (10).

FIG. 10 shows a bird's eye view of the Safe-T-Ox Cart with the saddle device in the locked position. From this view you can see the anterior (1) and segments of the posterior (2) portion of the saddle device, as well as, the handle (7), base (9), and the back segments of both wheels (10).

FIG. 11 shows an anterior view of the saddle device. From this view you can both anterior (1) and posterior (2) portions of the saddle device.

FIG. 12 shows a bird's eye view of the saddle device. From this view you can see the anterior (1) portion of the saddle device designed to fit over the narrowing neck of the oxygen cylinder.

FIG. 13 shows a side view of the saddle device.

FIG. 14 shows an enlarged side view of the main body of the Safe-T-Ox Cart to allow for visualization of the receptacle area (4) for the saddle device and the posterior locking area (3). From this view you can see circular shape of the receptacle areas for the saddle device. This drawing also illustrates the protrusion and flatness of the posterior locking area (3).

FIG. 15 shows an enlarged posterior view of the main body of the Safe-T-Ox Cart to allow for visualization of the receptacle areas (4, 5) for the saddle device and the posterior locking area (3). From this view you can see the circular shape of the posterior keyed locking area (3), as well as, the flatness of the receptacle areas for the saddle device (4, 5).

FIG. 16 shows the main body of the Safe-T-Ox Cart as it is molded. This drawing illustrates the main body of the Safe-T-Ox Cart prior to the wheels and saddle device being assembled.

### DETAILED DESCRIPTION OF INVENTION

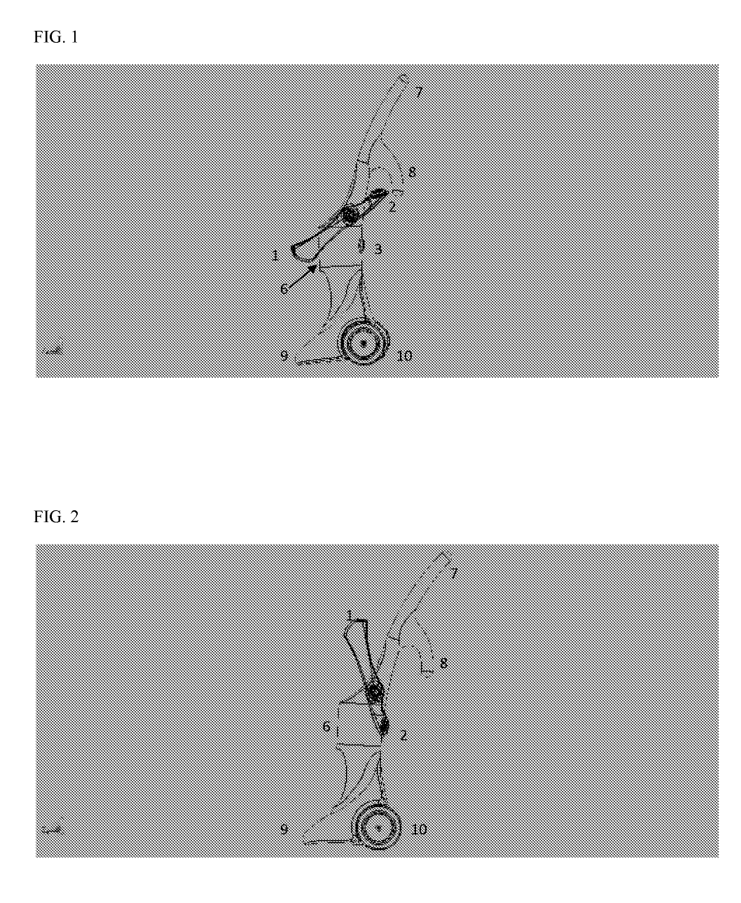

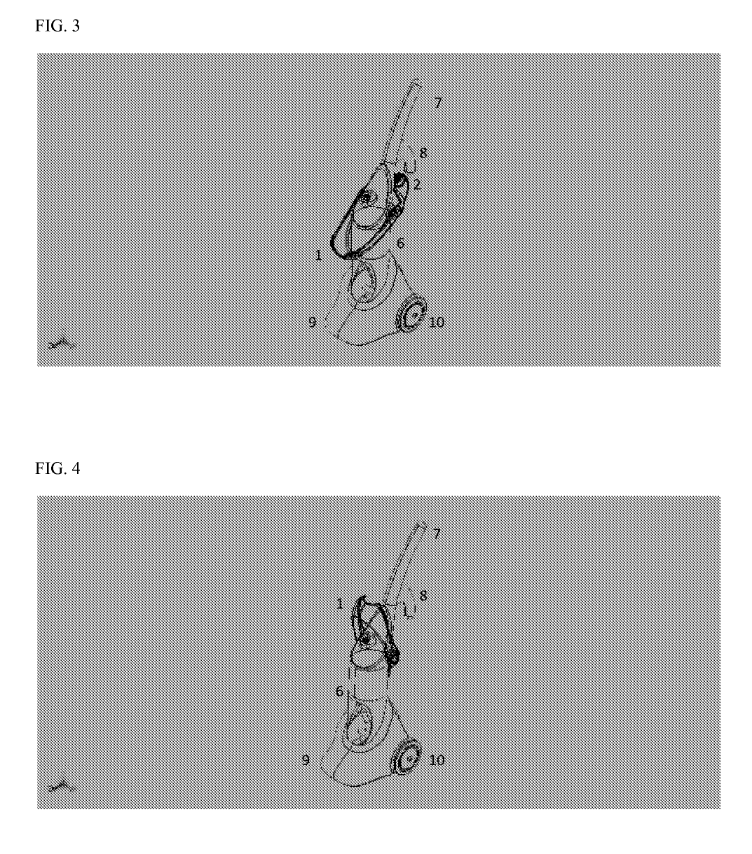

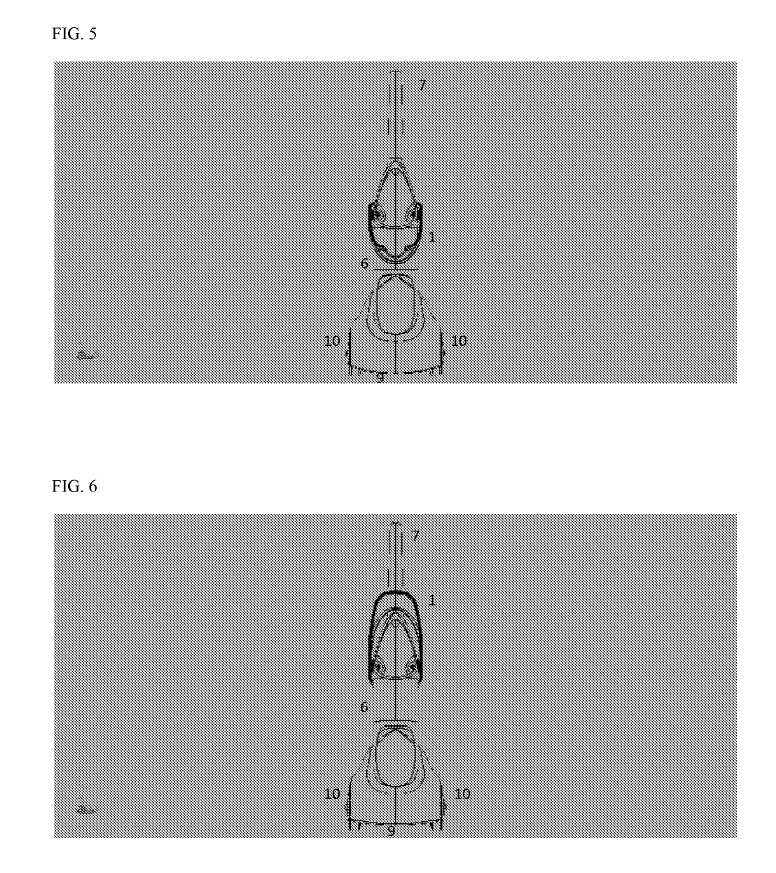

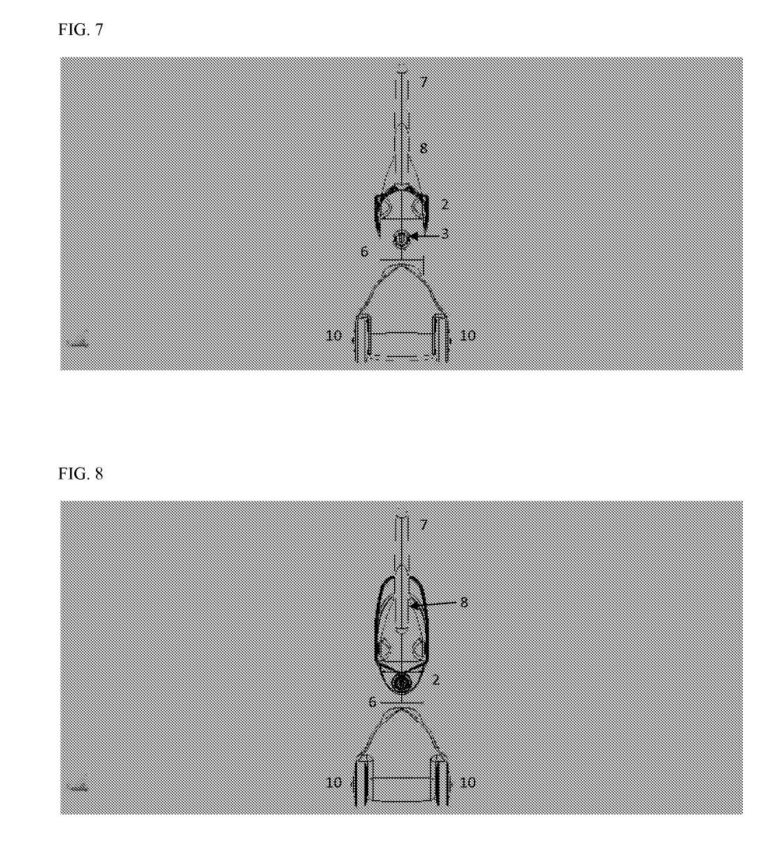

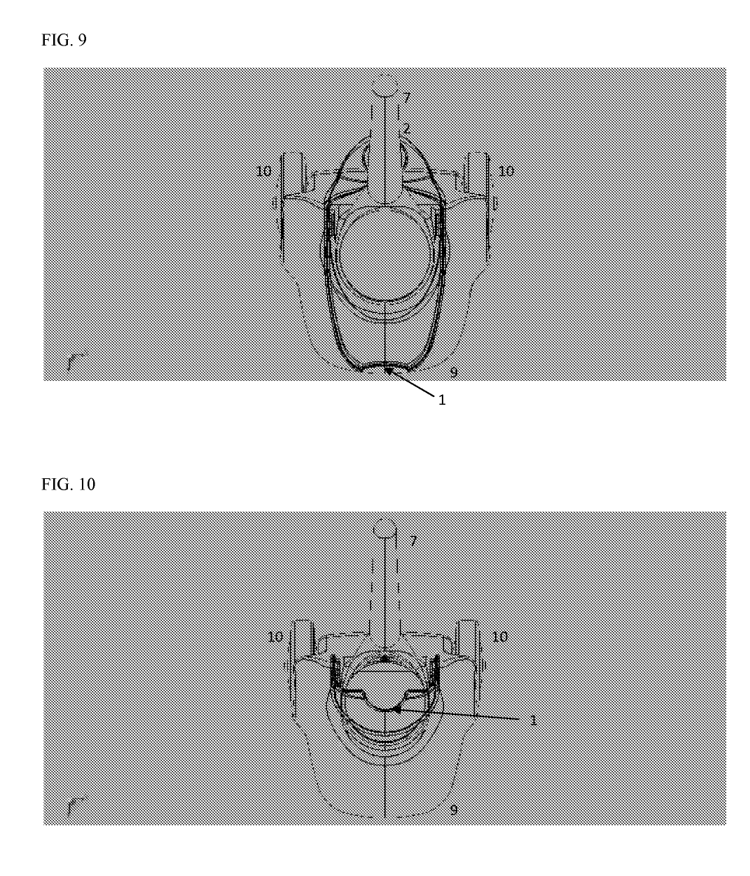

To further explain the functionality and composition of the Safe-T-Ox Cart, accompanying drawings will be referenced to precisely illustrate the invention. As discussed earlier, the anterior retainer (1) and posterior keyed lock (2) work together to secure the cylinder within the cart, as well as allow for removal of the cylinder (FIGS. 1-10). Upon locking the cylinder into the Safe-T-Ox Cart the anterior latch device hinges in and upward (FIGS. 2, 4, 6, 10) over the narrowing neck of the cylinder, this action causes the posterior keyed lock area to inversely hinge downward (FIGS. 2, 4, 8) toward the posterior spine of the cart, where the lock is then locked using a key. In addition, when removal of the cylinder is desired, the posterior keyed lock is unlocked and hinged upward (FIGS. 1, 3, 7, 9), away from the posterior spine of the cart, thus causing the anterior latch device to hinge out and downward (FIGS. 1, 3, 5, 9) away from the neck of the cylinder, allowing for removal of the cylinder.

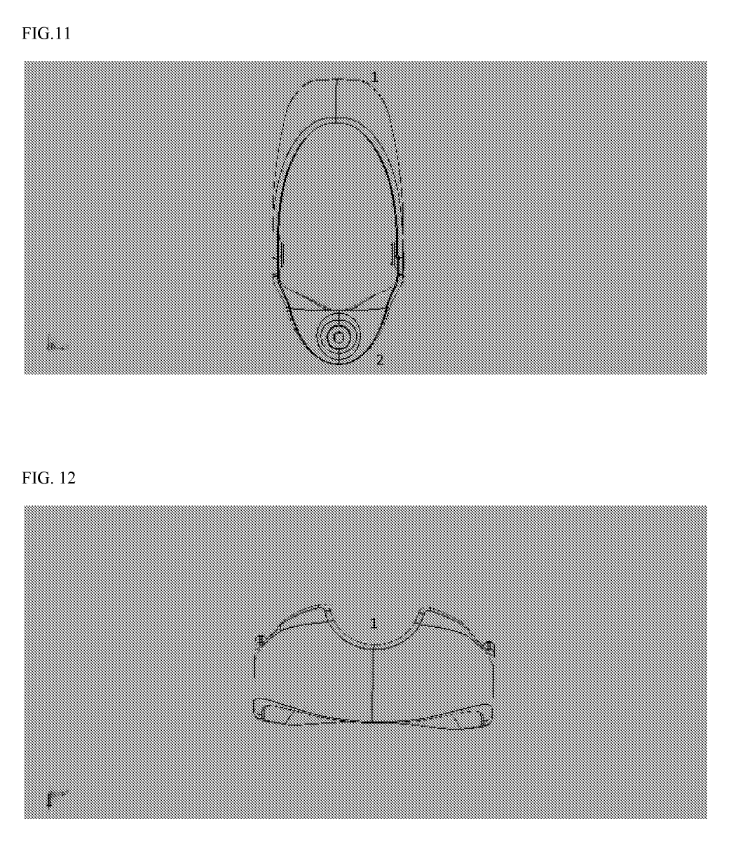

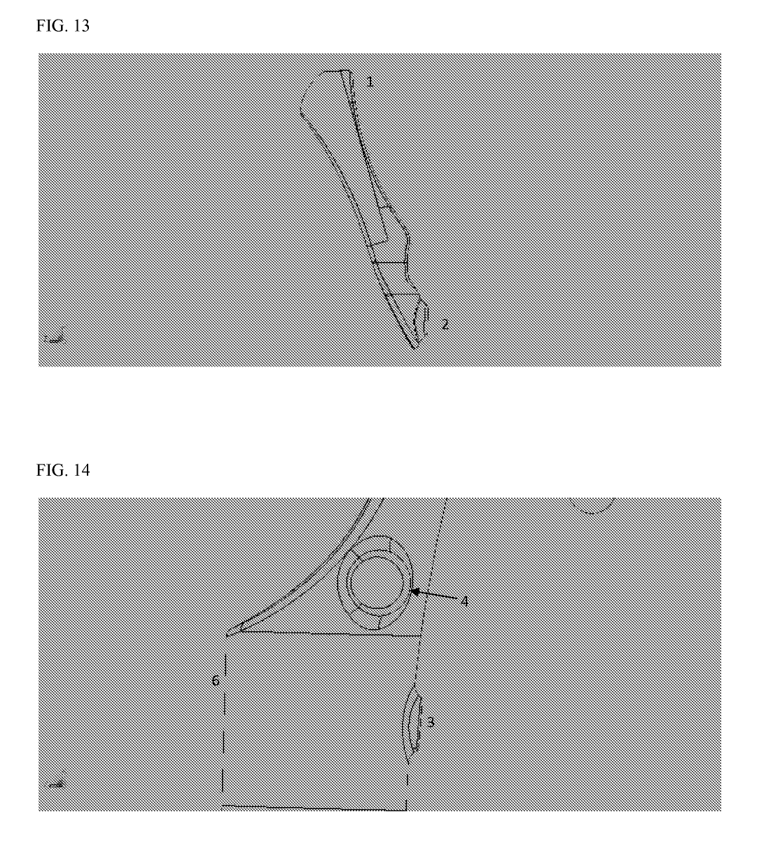

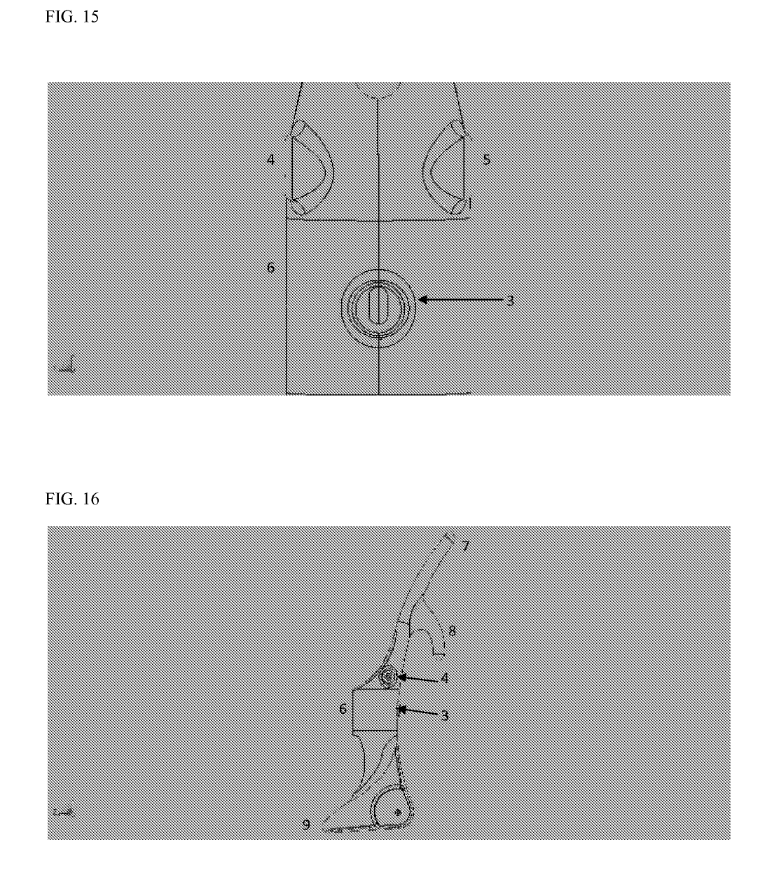

The main body (6) of the Safe-T-Ox Cart is designed with two receptacle areas (4, 5) which allow the saddle (FIGS. 11, 12, 13) to mount to and hinge as one with the invention. These two areas are located along the exterior sides of the Safe-T-Ox Cart. The receptacle areas are circle shaped and 2 inches in diameter (FIG. 14). They are flat to allow the saddle to hinge smoothly over their exterior surface (FIG. 15). The saddle device attaches to the receptacle areas by means of 2 half inch binding post sets. One binding post set is used on each side and acts as the pivot point for the saddle to hinge on.

Along the posterior segment of the Safe-T-Ox Cart's spine is the receptacle area (3) designed to receive the keyed lock, located on the posterior portion of the saddle device (2). The lock's receptacle area is circular in shape (FIG. 15), flat (FIG. 14), located 13.5 inches from the bottom of the Safe-T-Ox Cart, and is 1.5 inches in diameter. The lock's receptacle is molded as one with the main body of the Safe-T-Ox Cart (FIG. 16), and is drilled out during the final stages of manufacturing to receive and function with the lock. The saddle device locks to the main body of the Safe-T-Ox Cart by using a standard ¾ cam lock, ⅝′ in length, with a ⅝″ cam.

The Safe-T-Ox Cart is manufactured by a method referred to as rotational molding, also known as roto-molding. This method was chosen due to its' distinct advantages when manufacturing parts cylindrical in shape, and medium to large in size. High density polyethylene, commonly referred to as HDPE, is the material of choice for manufacturing the Safe-T-Ox Cart. HDPE is a commonly used material of choice for the manufacturing of plastic products. HDPE produces solid and durable parts.

The Safe-T-Ox Cart is manufactured in two parts. One manufacturing tool molds the main body (6) segment of the cart, including the receptacle areas for the saddle and the posterior receptacle area for the locking device (FIG. 16). A second manufacturing tool molds the saddle consisting of the anterior retainer (1) and the posterior housing segment for the keyed lock (2) (FIGS. 11, 12, 13).

What I claim as my invention is:

1. The Safe-T-Ox Cart consisting of a saddle device, which is attached to the cart itself, and serves the purpose of locking the oxygen cylinder into the Safe-T-Ox Cart.

2. In accordance to claim 1, the saddle device is comprised of a retainer, on the anterior portion of the saddle device, and a keyed locking area, located on the posterior portion of the saddle device.

3. In accordance to claim 1, two flat circular areas, located on either side of the main body of the cart, serve as receptacle areas to attach the saddle device to the main body of the Safe-T-Ox Cart.

4. In accordance to claim 1, a protruding, flat circular receptacle area on the posterior spine of the main body, of the Safe-T-Ox Cart, serves as a receptacle area for the keyed locking portion of the saddle.
